(19) United States
(12) Patent Application Publication
(10) Pub. No.: US 2026/0166574 A1
(43) Pub. Date: Jun. 18, 2026

(54) NOZZLE FOR VISCOUS TWO-COMPONENT SEALANTS

(71) Applicants: Baxter International Inc., Deerfield, IL (US); Baxter Healthcare SA, Glattpark (Opfikon) (CH)

(72) Inventor: Christopher Moss, Wheeling, IL (US)

(21) Appl. No.: 19/425,394

(22) Filed: Dec. 18, 2025

Related U.S. Application Data
(60) Provisional application No. 63/735,722, filed on Dec. 18, 2024.

(51) Int. Cl. B05B 7/08; B05B 7/24

(52) U.S. Cl. CPC B05B 7/0876; B05B 7/2464

(57) ABSTRACT

A gasless spray tip assembly for mixing and dispensing multi-component compositions includes a body defining a cannula; an insert configured to fit within a portion of the cannula; and a cap configured to secure with the body. The cap includes a plurality of channels tangent to and in fluid communication with a hollow chamber and an outlet orifice in fluid communication with the hollow chamber. A width of each of the plurality of channels is between about 0.1 mm and 0.3 mm, and a diameter of the hollow chamber is between about 0.65 to about 0.85 mm.

### CROSS-REFERENCE TO RELATED APPLICATIONS

The present application claims the benefit of U.S. Provisional Application No. 63/735,722, entitled NOZZLE FOR VISCOUS TWO-COMPONENT SEALANTS and filed Dec. 18, 2024, the contents of which are hereby incorporated by reference in their entirety.

### BACKGROUND

High viscous fluids, such as hemostats, sealants, and adhesion barriers may be applied to surgical sites using dispensing devices or spray systems. The hemostats, sealants, and adhesives may be multi-component fluids that need to be separated prior to dispensing. For example, several fluid constituents may be mixed together to form a biological sealant or adhesive. The fluid components react quickly and harden into the sealant or adhesive after they are mixed. Because of the rapid reactivity following component contact, mixing the fluid components occurs only when the multi-component fluid is ready to be dispensed and applied.

The dispensing devices may mix and dispense the multi-component fluids. Current spray systems include gas-assisted spray systems. However, gas-assisted spray systems are expensive to maintain and may require long set-up times. For example, some gas systems require a hospital to maintain a supply of a large compressed gas cylinder, and often require the setup of both tubing sets and a pressure or flow regulator system, which adds to the overall setup time. Other systems include a portable source of pressurized gas, such as a gas cartridge and a battery. However, complications during surgery may arise in the event the batteries are dead or there is a depleted gas supply.

Other systems for administering high viscous fluids do not require gas, but these systems may suffer from performance issues. For example, these systems may provide a spray over a wide area, but the spray may not be controlled such that it may be difficult to control where the sealant goes in the patient.

There remains a need for improved gasless spray systems, such as pressure swirl atomizers, that are suited for delivering high viscous fluids, such as hemostats, sealants, and adhesion barriers at low flow rates and low pressure.

### SUMMARY

The present disclosure provides a gasless spray system for mixing and dispensing multi-component compositions (e.g., sealants). The spray system may be used to apply the viscous multi-component sealant or adhesion barrier over a wide area without the need for a gas source. Further, the spray system may allow for precise application, which is not found with other gasless systems. The present inventors have found that specific geometries of a spray tip assembly provide these improved characteristics.

In light of the disclosure herein, and without limiting the scope of the invention in any way, a first aspect of the present disclosure, which may be combined with any other aspect listed herein unless specified otherwise, provides a spray tip assembly for providing a multi-component fluid, the spray tip assembly comprising a body comprising a cannula; an insert configured to fit within a portion of the cannula; and a cap configured to secure with the body, the cap comprising a plurality of channels tangent to and in fluid communication with a hollow chamber. The cap may further comprise an outlet orifice in fluid communication with the hollow chamber. A width of each of the plurality of channels may be between about 0.1 mm and 0.3 mm, and a diameter of the hollow chamber may be between about 0.65 to about 0.85 mm.

According to a second aspect of the present disclosure, which may be combined with any other aspect listed herein, the diameter of the hollow chamber is about 0.75 mm.

According to a third aspect of the present disclosure, which may be combined with any other aspect listed herein, the plurality of channels comprises two channels.

According to a fourth aspect of the present disclosure, which may be combined with any other aspect listed herein, the outlet orifice is concentric with and smaller than the hollow chamber.

According to a fifth aspect of the present disclosure, which may be combined with any other aspect listed herein, the width of each of the plurality of channels is about 0.2 mm.

According to a sixth aspect of the present disclosure, which may be combined with any other aspect listed herein, each of the plurality of channels comprises a rectangular cross-section.

According to a seventh aspect of the present disclosure, which may be combined with any other aspect listed herein, a depth of the hollow chamber is between about 0.15 mm and 0.35 mm.

According to an eight aspect of the present disclosure, which may be combined with any other aspect listed herein, the depth of the hollow chamber is about 0.25 mm.

According to a ninth aspect of the present disclosure, which may be combined with any other aspect listed herein, the spray tip assembly further comprises a connector removably coupled to an end of the body, wherein the connector comprises at least two channels extending along a length of the connector and in fluid communication with the cannula of the body.

According to a tenth aspect of the present disclosure, which may be combined with any other aspect listed herein, an outside diameter of the body is less than 5.5 mm.

According to an eleventh aspect of the present disclosure, which may be combined with any other aspect listed herein, the portion of the cannula for fitting the insert has a diameter of between 3 mm and about 4 mm.

According to a twelfth aspect of the present disclosure, which may be combined with any other aspect listed herein, a depth of the plurality of channels is between about 0.1 mm to about 0.3 mm.

According to a thirteenth aspect of the present disclosure, which may be combined with any other aspect listed herein, the outlet orifice has a diameter of between about 0.25 mm and 0.45 mm.

According to a fourteenth aspect of the present disclosure, which may be combined with any other aspect listed herein, the outlet orifice has a length of between about 0.1 mm and 0.4 mm.

According to a fifteenth aspect of the present disclosure, which may be combined with any other aspect listed herein, the insert comprises a plurality of protrusions surrounding at least a portion of an outside surface of the insert.

According to a sixteenth aspect of the present disclosure, which may be combined with any other aspect listed herein, the insert comprises a proximal end and a distal end, wherein the proximal end comprising a flat surface.

According to a seventeenth aspect of the present disclosure, which may be combined with any other aspect listed herein, the insert comprises a ridge and wherein a width of the insert with the ridge is substantially the same as or greater than a diameter of the portion of the cannula.

According to an eighteenth aspect of the present disclosure, which may be combined with any other aspect listed herein, the body comprises a post extending from an end of the body and wherein the post seals the hollow chamber.

According to a nineteenth aspect of the present disclosure, which may be combined with any other aspect listed herein, the post comprises a width of between about 1.0 mm and 2.0 mm.

According to a twentieth aspect of the present disclosure, which may be combined with any other aspect listed herein, the cap comprises a collar extending around the outlet orifice.

According to a twenty-first aspect of the present disclosure, which may be combined with any other aspect listed herein, a system for mixing and dispensing a two-component fluid is provided. The system comprising a first fluid source containing a first component of the two-component fluid, a second fluid source containing a second component of the multi-component, and a spray tip assembly. The spray tip assembly comprises a body comprising a cannula, wherein the cannula is fluid communication with the first fluid source and the second fluid source; an insert configured to fit within a portion of the cannula; and a cap configured to secure with the body. The cap comprises a plurality of channels tangent to and in fluid communication with a hollow chamber and an outlet orifice in fluid communication with the hollow chamber. A width of each of the plurality of channels is between about 0.1 mm and 0.3 mm. A diameter of the hollow chamber is between about 0.65 to about 0.85 mm.

According to a twenty-second aspect of the present disclosure, which may be combined with any other aspect listed herein, the first component comprises thrombin, and the second component comprises fibrinogen.

According to a twenty-third aspect of the present disclosure, which may be combined with any other aspect listed herein, the first fluid source and the second fluid source each comprise a syringe.

According to a twenty-fourth aspect of the present disclosure, which may be combined with any other aspect listed herein, the first fluid source and the second fluid source comprises a dual barrel syringe.

According to a twenty-fifth aspect of the present disclosure, which may be combined with any other aspect listed herein, a spray tip assembly system for providing a multi-component fluid is provided. The spray tip assembly system comprises: a body comprising a cannula; an insert configured to fit within a portion of the cannula; and a first cap and a second cap. Each of the first cap and the second cap are configured to secure with the body. The first cap comprises a plurality of channels tangent to and in fluid communication with a hollow chamber, the hollow chamber in fluid communication with an outlet orifice, wherein a width of each of the plurality of channels is between about 0.1 mm and 0.3 mm, and wherein a diameter of the hollow chamber is between about 0.65 to about 0.85 mm. The second cap comprised a conical opening leading to an orifice, the orifice with a diameter of between 0.3 mm and 0.5 mm.

According to a twenty-sixth aspect of the present disclosure, which may be combined with any other aspect listed herein, the first cap and the second cap provide different spray patterns of the multi-component fluid.

According to a twenty-seventh aspect of the present disclosure, which may be combined with any other aspect listed herein, the first cap and the second cap are removably couple to the body depending on a desired spray pattern.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 illustrates a perspective view of a spray tip assembly according to an example of the present disclosure.

FIG. 2 illustrates an expanded view of the components of a spray tip assembly according to an example of the present disclosure.

FIG. 3 illustrates a cross-sectional view of a spray tip assembly according to an example of the present disclosure.

FIG. 4 illustrates a side view of a connector of a spray tip assembly according to an example of the present disclosure.

FIG. 5 illustrates a cross-sectional view of a connector of a spray tip assembly according to an example of the present disclosure.

FIGS. 6 and 7 illustrate end portions of a connector of a spray tip assembly according to an example of the present disclosure.

FIG. 8 illustrates a side view of a tip body of a spray tip assembly according to an example of the present disclosure.

FIG. 9 illustrates a cross-sectional view of a tip body of a spray tip assembly according to an example of the present disclosure.

FIGS. 10, 11A, and 11B illustrate end portions of a tip body of a spray tip assembly according to an example of the present disclosure.

FIG. 12 illustrates a side view of an insert of a spray tip assembly according to an example of the present disclosure.

FIG. 13 illustrates a cross-sectional view of an insert of a spray tip assembly according to an example of the present disclosure.

FIG. 14 illustrates an alternate side view of an insert of a spray tip assembly according to an example of the present disclosure.

FIGS. 15 and 16 illustrate end portions of an insert of a spray tip assembly according to an example of the present disclosure.

FIG. 17 illustrates a perspective view of a tip cap of a spray tip assembly according to an example of the present disclosure.

FIG. 18 illustrates a cross-sectional view of a tip cap of a spray tip assembly according to an example of the present disclosure.

FIGS. 19 and 20 illustrate end portions of a tip cap of a spray tip assembly according to an example of the present disclosure.

FIG. 21 illustrates a perspective view of a tip cap of a spray tip assembly according to another example of the present disclosure.

FIG. 22 illustrates a cross-sectional view of a tip cap of a spray tip assembly according to another example of the present disclosure.

FIGS. 23 and 24 illustrate end portions of a tip cap of a spray tip assembly according to another example of the present disclosure.

FIG. 25 illustrates a perspective view of a spray tip assembly according to an example of the present disclosure.

FIG. 26 illustrates cross-sectional views of a tip body of a spray tip assembly according to an example of the present disclosure.

FIG. 27 illustrates a cross-sectional view of a tip cap of a spray tip assembly according to an example of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well¬-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein the term “about” means approximately, in the region of, roughly, or around. When the term “about” is used in conjunction with a numerical value or range, it modifies that value or range by extending the boundaries above and below the numerical value(s) set forth. In general, the terms “about” and “approximately” are used herein to modify a numerical value(s) above and below the stated value(s) by 10%.

The present disclosure generally describes a gasless spray tip assembly for delivering two-component viscous fluids. Spray tip assemblies according to the present disclosure show reliable and improved spray characteristics. The spray tip assembly facilitates the mixing and spraying of two components from a fluid source, such as a syringe. Until mixing in the spray tip, the fluid streams are not in fluid communication, since polymerization of the components begins rapidly after the components meet. In some embodiments, the spray tip assembly delivers a spray of well mixed, but not polymerized, sealant to the target tissue site.

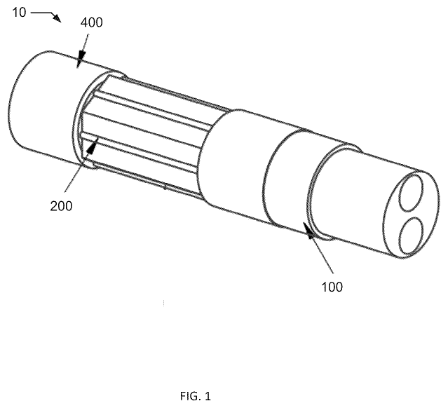

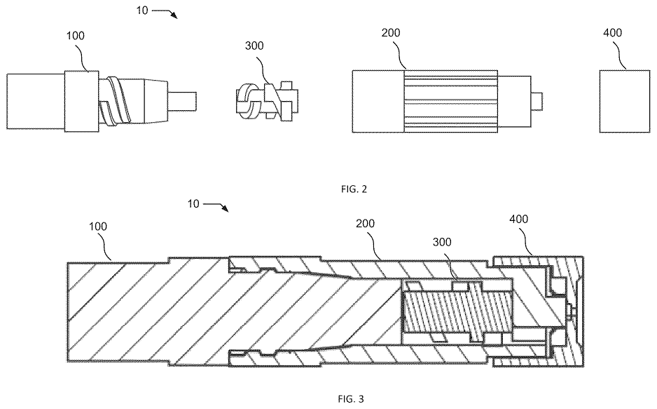

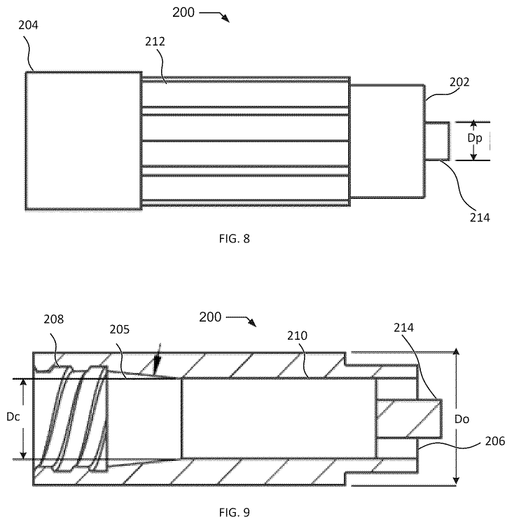

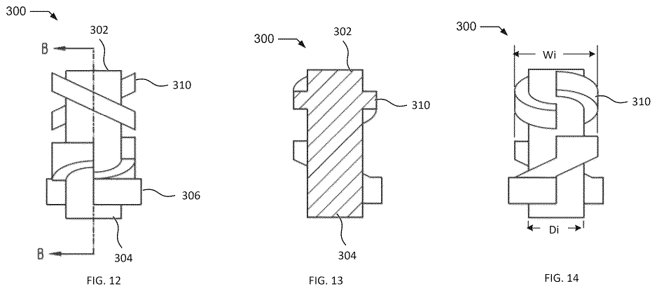

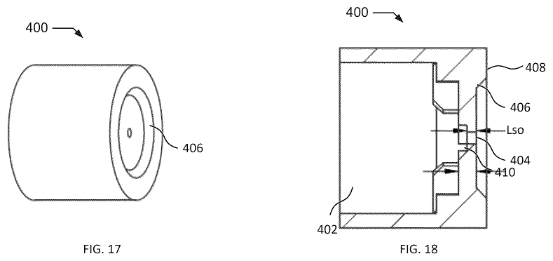

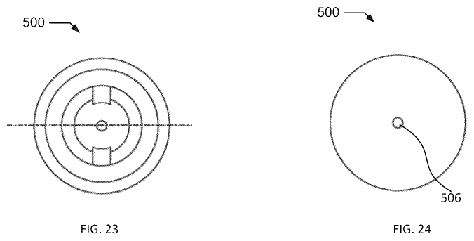

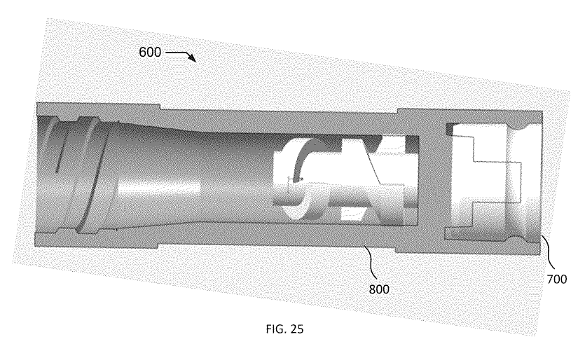

Referring to the drawings, FIGS. 1 through 3 illustrate example embodiments of a spray tip assembly 10 for delivering viscous two-component fluids. The spray tip assembly may include a connector 100 as illustrated in FIGS. 4-7, a spray tip body 200 as illustrated in FIGS. 8 through 11, an insert 300 as illustrated in FIGS. 12 through 16, and a tip cap 400, 500 as illustrated in FIGS. 17 through 24. In some embodiments, the spray tip assembly 10 can be used with differing tip caps 400, 500 depending on the desired application. For example, tip cap 400 may be a spray nozzle while tip cap 500 may be a drip nozzle.

Fluid from a fluid source, such as a syringe, travels separately through fluid channels within the connector 100 and into the spray tip body 200. In some embodiments, depression of the syringe pushes fluid from the fluid source and into the spray tip assembly 10. The insert 300 within the spray tip body 200 mixes the components of the multi-component fluid. After mixing by the insert 300, the fluid exits the spray tip assembly 10 through the tip cap 400, 500 designed for the desired spray profile. For example, the tip cap 400, 500 includes a specific geometry that provides controlled spraying of the sealant or adhesive to the surgical site.

### Connector

FIGS. 4 to 7 illustrate a connector 100 according to an example of the present disclosure. The connector 100 may include a generally cylindrical body with multiple portions of differing diameter. The connector 100 may include one or more fluid channels, such as a first fluid channel 110 and a second fluid channel 112, extending through a length of the connector 100. The fluid channels 110, 112 may be separate so that the fluid in each channel does not mix. For example, as shown in the depicted embodiment, the channels 110, 112 may be substantially parallel to each other. Each channel 110, 112 may include a first portion 110a, 112a of a first diameter and a second portion 110b, 112b of a second diameter. In some embodiments, the diameter of the second portion 110b, 112b may be smaller than the diameter of the first portion 110a, 112a.

The first portions 110a, 112a of the two fluid channels 110, 112 may be configured to receive a first fluid source and a second fluid source, respectively. In some embodiments, the first fluid source and the second fluid source may include a syringe, such as two syringes or a dual barrel syringe. In some embodiments, the fluid in the first fluid source and fluid in the second fluid source may combine to produce a biological sealant or adhesive. For example, the first fluid source may include thrombin and the second fluid source may include fibrin, such as fibrinogen. Upon mixing, the two fluid components may react quickly and harden into the sealant or adhesive. Therefore, it may be advantageous to keep the fluid channels separate until mixing and application occurs.

An external surface of the connector 100 may include one or more threads 120 configured to engage with other components of the spray assembly 10, such as the spray tip body 200. Proximal to the threads 120, an external surface of the connector 100 may include a collar 130 configured to serve as a stopper that abuts the spray tip body 200 when the spray tip body 200 is coupled to the connector 100. The outer diameter of the collar 130 may be substantially the same as the outer diameter of the spray tip body 200 as shown in FIG. 1. In some embodiments, an outer surface of an end portion of the connector 100 includes a tapered portion 150, which tapers toward the end.

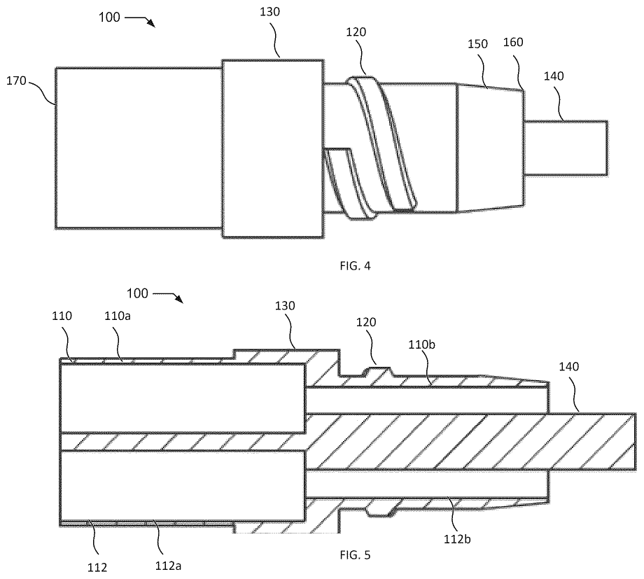

The connector 100 may include a post 140 between the two fluid channels 110, 112 extending at least a portion of the length of the connector 100. The post 140 may include a width greater than a height. The post 140 may extend outward from a distal portion of the connector 100 as shown in FIG. 5. The post 140 may be used to keep the fluid in the two fluid channels 110, 112 separate when traveling through a portion of the spray assembly 10. Specifically, the post 140 and the two fluid channels 110, 112 ensure the fluids remain isolated until they reach the insert 300 within the spray tip body 200, where the fluids start to mix.

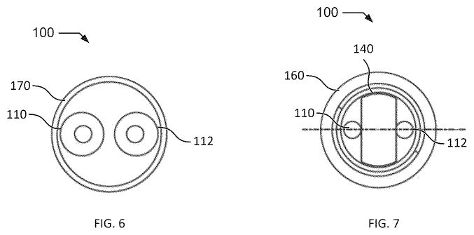

FIG. 6 illustrates a proximal end 170 of the connector 100. The proximal end 170 of the connector 100 may include an opening of the two fluid channels 110, 112. FIG. 7 illustrates a distal end 160 of the connector 100. As depicted, the distal end 160 includes an opening of the two fluid channels 110, 112 and the post 140 extending between the two channels.

### Spray Tip Body

FIGS. 8 to 11 illustrate a spray tip body 200 according to an example of the present disclosure. As illustrated in FIGS. 8 to 11, the spray tip body 200 may include an outlet end 202 and an attachment end 204.

The spray tip body 200 may include a threaded cannula portion 208 at the attachment end 104, which may facilitate removeable connection of spray tip body 200 to the connector 100, a syringe or other vessel. For example, threading or threads may threadingly engage with corresponding threading or threads 120 of the connector 100. The threading may provide a leak-tight seal between the spray tip body 200 and the connector 100. In another example, spray tip body 200 may include other attachment features to removably connect to or couple to the connector 100. For example, the spray tip body 200 may be press-fit and may maintain a friction fit with the connector 100. Additionally or alternatively, the spray tip body 200 may include a tapered portion 205, substantially matching and configured to receive the tapered portion 105 of the connector 100. The tapered portion 205 may create a seal between the connector 100 and the spray tip body 200 that prevents leakage of the fluid.

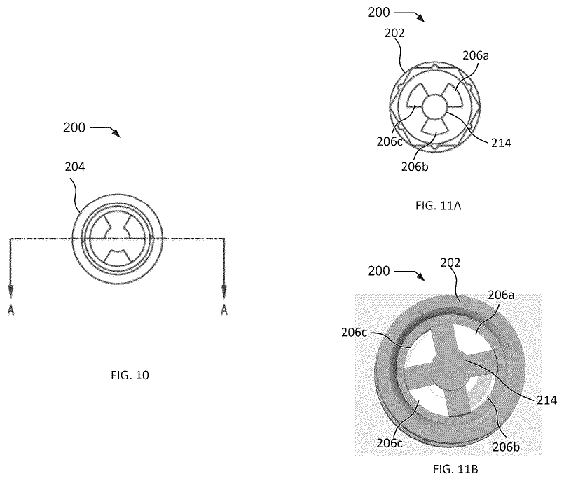

The outlet end 202 of the spray tip body 200 may include an outlet orifice 206. In some embodiments, the outlet orifice 206 may include one or more apertures or channels (e.g. 206a, 206b, 206c) extending around post 214. As depicted in FIG. 11A, the one or more apertures may include two arcuate sides and two straight sides. As depicted in FIG. 11B, in some embodiments, the one or more apertures may include four apertures or channels (i.e. 206a, 206b, 206c, 206d) extending around post 214 with a cross-shaped support. However, it can be appreciated that other suitable geometries may be used. The post 214 separating outlet orifice 206 may extend past the outlet end 202 of the spray tip body 200 as shown in FIGS. 8 and 9. In some embodiments, the post 214 interacts with the spray tip 400, 500 when the spray tip assembly 10 is assembled. For example, the post 214 may direct fluid to outer portions of the spray tip 400, 500 for improved spray characteristics. The post 214 may be cylindrical. In some embodiments, the outer diameter Dₚ of the post 214 is between 1.0 mm and 2.0 mm, more preferably about 1.5 mm.

An outside surface of the spray tip body 200 may include a gripping portion 212. The gripping portion 212 may include ridges, protrusions, a textured surface, or other surface finish or surface geometry that aids with gripping the spray tip body 200. In some embodiments, gripping portion 212 includes a hexagonal cross-section with raised ridges along the length of the hexagonal sides as shown in FIG. 11. It can be appreciated that other geometrical cross-sections may be used, such as a square, a triangle, a pentagon, an octagon, etc. The gripping portion 212 may allow a user to easily grasp the spray tip assembly with surgical graspers. The gripping portion may also aid a user in removing the spray tip body 200 from the connector 100. In some embodiments, a largest width of the gripping portion may be less than an outer diameter Dₒ of spray tip body 200.

The spray tip body 200 may be generally cylindrical and may include a hollow chamber 210 distal to the threaded cannula portion 208. The chamber 210 may be configured to receive an insert 300, which will be described in more detail herein. The size and shape of the chamber 210 may be optimized for improved spraying characteristics of the viscous compositions. Further, an outer diameter of the spray tip body 200 may be sized to enable access to certain areas for delivery of the composition. In some embodiments, the spray tip assembly 10 may be used in laparoscopic procedures requiring an outer diameter Dₒ of less than 5.5 mm, such as between 5.0 mm and 5.5 mm, more preferably about 5.4 mm.

In some embodiments, the chamber 210 is sized depending on the specification required for the outer diameter of the spray tip body 200. For example, the chamber 210 may be sized such that the wall thickness of the spray tip body 200 is thick enough to maintain rigidity. In some embodiments, the chamber diameter D_{c} is between about 3 mm and about 4 mm, more preferably about 3.3 mm.

### Spray Tip Insert

FIGS. 12 to 16 illustrate an insert 300 according to an example of the present disclosure. In an example, the tip insert 300 is removably coupled to the spray tip body 200, such as in the chamber 210, via a press fit. For example, the insert 300 may include one or more ribs 306 giving the insert 300 a width substantially the same as or slightly larger than the diameter of the chamber 210. In some embodiments, the width of the insert is between about 0.05 mm and 0.15 mm, such as about 0.05 mm, 0.1 mm, or 0.15 mm greater than the chamber 210 diameter D_{c}. Alternatively, the insert 300 may be non-removably assembled to the spray tip body 200.

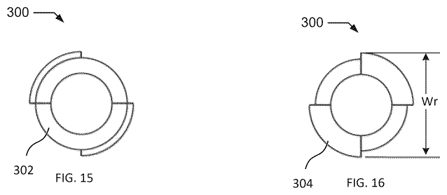

As fluid is pushed through the spray tip assembly 10 from the fluid source, the fluid enters the chamber 210 housing the insert 300. The insert 300 forces the fluid to the outermost edge of the chamber 210 between the insert 300 and the wall of the chamber 210. As more fluid enters chamber 210, the fluid is pushed through the chamber 210 and out of the outlet orifice 206 of the spray tip body 200. The insert 300 may have a proximal end 302 illustrated in FIG. 15 and a distal end 304 illustrated in FIG. 16 closest to the outlet orifice 206 when housed within the spray tip body 200. The proximal end 302 may include a blunt or flat fluid contact surface, which may be the first surface the fluid encounters.

To aid in mixing of non-homogenous components before administration (e.g. surgical hemostats, sealants, or adhesion barriers), the insert 300 may include a plurality of protrusions 310 (e.g., mixing protrusions) positioned around the surface of the insert 300. In the illustrated example, the insert 300 includes two protrusions 310 in a staggered cross pattern. In an example, the mixing protrusions 310 may be oriented at different axial positions (e.g., 30 degrees, 45 degrees, etc.). The protrusions 310 may be spaced to optimize the mixing of the fluid. FIGS. 12 to 14 illustrate an example protrusion 310 geometry surrounding a portion of the insert 300. As illustrated, the protrusions 310 may crisscross, respectively. Other protrusion 310 geometries may be used, for example, the posts may be helical, triangular, etc. In some embodiments, the insert 300 may be symmetrical around the center so that the proximal and distal ends of the insert are the same. This may allow the insert 300 to be secured within the chamber 210 in any orientation.

The insert 300 may be sized to fit into the chamber 210, so the size and shape of the insert 300 may depend on the required specifications of the spray tip body 200. In some embodiments, the insert 300 is generally cylindrical. The insert 300 may have a diameter Dᵢ of between about 1.5 mm and 2.5 mm, more preferably about 2 mm. In some embodiments, the width Wᵢ of the insert 300 with the protrusion 310 is between 2.5 mm and 3.5 mm, more preferably 3.0 mm. In some embodiments, the width Wᵣ of the insert 300 with the one or more ribs 306 is between 3.0 mm and 3.8 mm, more preferably 3.4 mm. In other embodiments, the insert 300 is any desired shape.

### Tip Cap

FIGS. 17 to 20 illustrate a tip cap 400 according to an example of the present disclosure. Tip cap 400 may be configured to act as a spray nozzle. Tip cap 400 may be generally cylindrical. In some embodiments, the largest width of the tip cap 400, such as the diameter of the cylinder, is substantially the same as the external diameter of the tip body 200. For example, the diameter of the tip cap 400 may be less than 5.5 mm, such as between 5.0 mm and 5.5 mm, more preferably about 5.4 mm.

The tip cap may include a cannula 402 extending from one end of the tip cap 400 to the other end of the tip cap 400. A portion of the cannula 402 may be configured to receive outlet end 202 the tip body 200. Another end of the tip cap 400 may include a spraying orifice 404. In some embodiments, the tip cap 400 may include a collar 406 surrounding the spray orifice 404. The collar 406 may include a tapering width from one end to the other. Alternatively, the collar 406 may include a constant diameter. The collar 406 may help guide the spray trajectory.

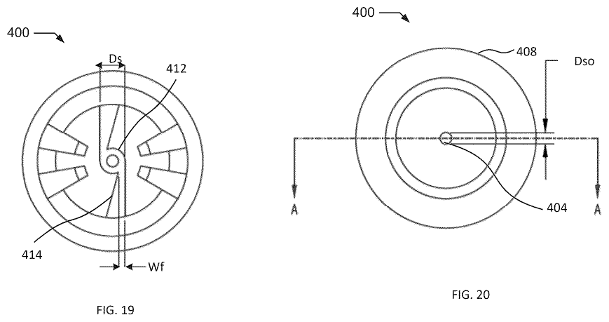

As illustrated in FIGS. 18 and 19, the distal end portion 408 (e.g. proximal to the spray orifice 404) may include a swirl chamber portion 410 for imparting rotation of the fluid as it exits the spray tip assembly 10. The swirl chamber portion 410 may include a swirl chamber 412 and a plurality of feeders 414 leading into the swirl chamber 410 as illustrated in FIG. 19. In some embodiments, the swirl chamber 412 is generally cylindrical in shape. In other embodiments, the swirl chamber 412 is generally conical or includes any suitable geometry. In some embodiments, the geometry and size of the swirl chamber 412 produces a preferred spray geometry of the viscous fluid.

As discussed, the tip cap 400 includes a plurality of feeders 414 tangent to the swirl chamber 412, which feed the fluid from the edge of the chamber 210 to the swirl chamber 412. In some embodiments, the tip cap 400 includes two feeders 414, three feeders 414, four feeders 414, five feeders 414, or any suitable number of feeders 414. In some embodiments, the feeders 414 have a square cross-section, a rectangular cross-section, or a trapezoidal cross-section. In some examples, the feeders 414 and the swirl chamber 412 are molded into the distal end portion 408 of the tip cap 400. The present inventors have determined that the size of the swirl chamber 412 and the feeders 414 impacts the spray characteristics of the spray tip assembly.

In some embodiments, the feeders 414 have a relatively small cross-section. The small cross section may increase initial fluid speed at a given flow rate. In some embodiments, the nominal width of each feeder W_{f} is between 0.1 mm and 0.3 mm, more preferably 0.2 mm. In some embodiments, the nominal depth of each feeder is between 0.15 mm and 0.35 mm, more preferably 0.25 mm.

As shown in FIG. 19, in some embodiments, the swirl chamber 412 may have a relatively short diameter Dₛ compared to the chamber 210. In some embodiments, the swirl chamber 412 may have a diameter Dₛ between about 0.65 mm to about 0.85 mm, more preferably 0.75 mm. Additionally or alternatively, in some embodiments, the depth of the swirl chamber 412 is between about 0.15 mm to about 0.35 mm, most preferably about 0.25 mm.

The liquid travels through the feeders 414 from the edge of the chamber 210 to the swirl chamber 412 where it spins around the swirl chamber 412 several times. The fluid then travels out of the spray orifice 404. In some embodiments, the spray orifice 404 is smaller than and concentric with the swirl chamber 412. As illustrated in FIGS. 18 and 20, the spray orifice 404 has a diameter Dₛₒ and a length Lₛₒ. The present inventors have also determined that adjusting the diameter and length of the spray orifice 404 affects the spray properties. In some embodiments, the spray orifice 404 has a diameter Dₛₒ of between about 0.25 mm and 0.45 mm, more preferably 0.35 mm or 0.40 mm, and a length Lₛₒ of between about 0.1 mm and 0.4 mm, more preferably 0.3 mm.

FIGS. 21 to 24 illustrate a tip cap 500 according to another example the present disclosure. Tip cap 500 may be interchangeable with tip cap 400 depending on the desired dispensing profile (e.g. spray or drip). Tip cap 500 may be configured to act as a drip nozzle. Tip cap 500 includes a cannula 502 extending along a length of tip cap 500. A first portion of the cannula may be configured to receive the tip body 200. A second portion of the cannula may include a conical opening 504 leading to an orifice 506 with a diameter of between 0.3 mm and 0.5 mm, more preferably 0.4 mm.

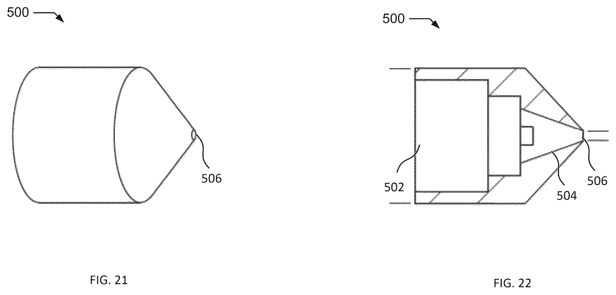

An external surface of tip cap 500 may include a cylindrical portion and a conical portion as depicted in FIGS. 21 and 22. It can be appreciated that the external geometry of the tip cap 500 may vary, such as a cylinder, a cone, a pyramid, or any suitable geometry. In some embodiments, the largest width of the tip cap 500, such as the diameter of the cylindrical portion, is substantially the same as the external diameter of the tip body 200. For example, the diameter of the cylindrical portion may be less than 5.5 mm, such as between 5.0 mm and 5.5 mm, more preferably about 5.4 mm.

### Assembly

Referring back to FIGS. 1 to 3, the connector 100, tip body 200, insert 300, and tip cap 400, 500 are assembled together to form the spray tip assembly 10. To assemble, the insert 300 may be inserted into proximal end 204 of the tip body 200 and into the chamber 210. The ribs 306 of the insert 300 may form an interference fit with an internal chamber 210 surface of the tip body 200. In some embodiments, the distal end 304 of the insert 300 contacts the post 214 of the tip body 200.

The tip cap 400, 500 may be secured to the outlet end 202 of the tip body 200. When tip cap 400 is secured to the tip body 200, the post 214 of the tip body 200 may lie flush against an interior surface of the tip cap 400. For example, the post 214 may seal the area over the spin chamber 412 and a part of the feeders 414. This may seal the liquid inside the spin chamber 412. Tip cap 500 may be inserted onto the outlet end 202 of the tip body 200 to form a strong bond between the two, such as an interference fit. In some embodiments, the tip caps 400, 500 may be secured to the tip body 200 using one of an adhesive, a welding, a snap, or any suitable securing method.

The connector 100 may connect to the attachment end 204 of the tip body 200 via the threads 120. The tapered section of the connector 100 may lie flush with the tapered section of the tip body 200. The fluid sources may engage with the fluid channels 110, 112 of the connector 100. Actuation of the fluid sources, such as depression of a plunger of a syringe, sends fluid from the fluid sources through fluid channels 110, 112 where the fluid enters the tip body 200 chamber 210. For example, when assembled, the fluid channels 110, 112 are in fluid communication with the chamber 210. The fluid may be separated until it is mixed using the insert 300 within chamber 210. The mixed fluid then advances to the feeders 414 and the swirl chamber 412 of the tip cap 400, 500 and sprays out the spray orifice 404 of the tip cap 400. The present inventors have surprisingly determined that the geometry of the swirl chamber portion and outlet orifice as described herein provides improved spray properties compared to current systems.

### Additional Embodiments

FIG. 25 illustrates a spray tip assembly 600 according to another example of the present disclosure. Various configurations/features/characteristics of spray tip assembly 600 may be similar to and/or the same as the ones described with respect to spray tip assembly 10 and thus, duplicate description may be omitted. In some embodiments, components of spray tip assembly 600 may be combined with any of the embodiments of the components of spray tip assembly 10.

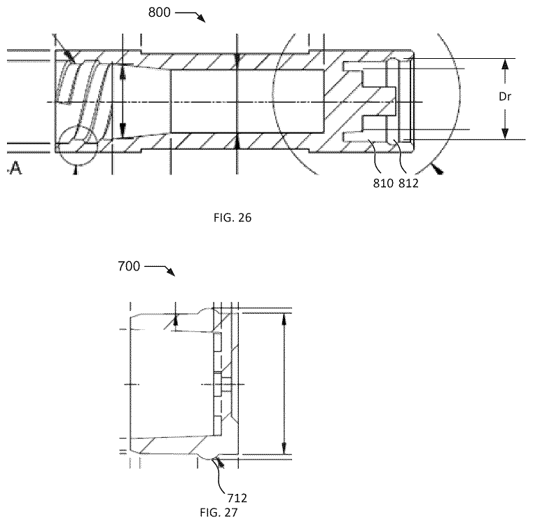

In some embodiments, the spray tip cap 700 of spray tip assembly 600 may be press fit into an end of spray tip body 800 as shown in FIG. 25. For example, as shown in FIG. 26, the spray tip body 800 may include a recess 810 at an end of the spray tip body 800. In some embodiments, the recess has a diameter Dᵣ of between 4.0 mm and 4.5 mm. The recess 810 may include an indentation 812 configured to receive a protrusion 712 of the spray tip 700 to secure the spray tip 700 within the spray tip body 800. It can be appreciated that other mechanisms for snap fitting the spray tip to the spray tip body may be used. In some embodiments, the external diameter of the spray tip 700 is slightly larger than the diameter of the recess 810; for example the external diameter of the spray tip 700 may be between 4.05 mm and 4.55 mm, such as approximately 0.05 mm larger than the diameter of the recess 810.

Aspects of the subject matter described herein may be useful alone or in combination with one or more other aspects described herein.

To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

The invention is claimed as follows:

1. A spray tip assembly for providing a multi-component fluid, the spray tip assembly comprising:
a body comprising a cannula;
an insert configured to fit within a portion of the cannula; and
a cap configured to secure with the body, the cap comprising a plurality of channels tangent to and in fluid communication with a hollow chamber,
the cap further comprising an outlet orifice in fluid communication with the hollow chamber,
wherein a width of each of the plurality of channels is between about 0.1 mm and 0.3 mm, and
wherein a diameter of the hollow chamber is between about 0.65 to about 0.85 mm.

2. The spray tip assembly of claim 1, wherein the diameter of the hollow chamber is about 0.75 mm.

3. The spray tip assembly of claim 1, wherein the plurality of channels comprises two channels.

4. The spray tip assembly of claim 1, wherein the outlet orifice is concentric with and smaller than the hollow chamber.

5. The spray tip assembly of claim 1, wherein the width of each of the plurality of channels is about 0.2 mm.

6. The spray tip assembly of claim 1, wherein each of the plurality of channels comprises a rectangular cross-section.

7. The spray tip assembly of claim 1, wherein a depth of the hollow chamber is between about 0.15 mm and 0.35 mm.

8. The spray tip assembly of claim 7, wherein the depth of the hollow chamber is about 0.25 mm.

9. The spray tip assembly of claim 1, wherein the spray tip assembly further comprises a connector removably coupled to an end of the body, wherein the connector comprises at least two channels extending along a length of the connector and in fluid communication with the cannula of the body.

10. A system for mixing and dispensing a two-component fluid, the system comprising:
a first fluid source containing a first component of the two-component fluid,
a second fluid source containing a second component of the multi-component, and
a spray tip assembly comprising:
a body comprising a cannula, wherein the cannula is fluid communication with the first fluid source and the second fluid source;
an insert configured to fit within a portion of the cannula; and
a cap configured to secure with the body, the cap comprising a plurality of channels tangent to and in fluid communication with a hollow chamber,
the cap further comprising an outlet orifice in fluid communication with the hollow chamber,
wherein a width of each of the plurality of channels is between about 0.1 mm and 0.3 mm, and
wherein a diameter of the hollow chamber is between about 0.65 to about 0.85 mm.

11. The system of claim 10, wherein a depth of the hollow chamber is between about 0.15 mm and 0.35 mm.

12. The system of claim 10, wherein an outside diameter of the body is less than 5.5 mm.

13. The system of claim 10, wherein the outlet orifice has a diameter of between about 0.25 mm and 0.45 mm.

14. The system of claim 10, wherein the outlet orifice has a length of between about 0.1 mm and 0.4 mm.

15. The system of claim 10, wherein the first component comprises thrombin, and the second component comprises fibrinogen.

16. The system of claim 10, wherein the first fluid source and the second fluid source each comprise a syringe.

17. The system of claim 10, wherein the first fluid source and the second fluid source comprises a dual barrel syringe.

18. A spray tip assembly system for providing a multi-component fluid, the spray tip assembly system comprising:
a body comprising a cannula;
an insert configured to fit within a portion of the cannula; and
a first cap and a second cap, each of the first cap and the second cap configured to secure with the body, the first cap comprising:
a plurality of channels tangent to and in fluid communication with a hollow chamber, the hollow chamber in fluid communication with an outlet orifice, wherein a width of each of the plurality of channels is between about 0.1 mm and 0.3 mm, and wherein a diameter of the hollow chamber is between about 0.65 to about 0.85 mm; and
the second cap comprising:
a conical opening leading to an orifice, the orifice with a diameter of between 0.3 mm and 0.5 mm.

19. The spray tip assembly system of claim 18, wherein the first cap and the second cap provide different spray patterns of the multi-component fluid.

20. The spray tip assembly system of claim 18, wherein the first cap and the second cap are removably couple to the body depending on a desired spray pattern.
